(19) United States
(12) Patent Application Publication
(10) Pub. No.: US 2021/0056562 A1
(43) Pub. Date: Feb. 25, 2021

(54) TRANSACTION AND IDENTITY VERIFICATION SYSTEM AND METHOD

(71) Applicant: GREEN CHECK VERIFIED INC., New Haven, CT (US)

(72) Inventors: Kevin J. HART, New Haven, CT (US); Michael P. KENNEDY, New Haven, CT (US); Paul A. DUNFORD, Hamden, CT (US)

(21) Appl. No.: 16/968,068

(22) PCT Filed: Feb. 8, 2019
(86) PCT No.: PCT/US2019/017191

§ 371 Date: Aug. 6, 2020

Related U.S. Application Data
(60) Provisional application No. 62/627,918, filed on Feb. 8, 2018.
(60) Provisional application No. 62/724,069, filed on Aug. 29, 2018.

(51) Int. Cl. G06Q 30/00; G06Q 30/02; G06Q 50/26; G06Q 10/10; G06Q 20/38; G06Q 40/02; G06Q 40/00; G06F 16/27

(52) U.S. Cl. CPC G06Q 30/0185; G06Q 30/0203; G06Q 50/265; G06Q 10/10; G06N 20/00; G06Q 40/02; G06Q 40/12; G06F 16/27; G06Q 20/389

(57) ABSTRACT

A transaction and identity verification system includes a processor and a memory including computer program code, where executing the computer program code by the processor causes the transaction and identity verification system to utilize a private permissioned distributed ledger to qualify users for different capabilities within the system, and verify identities and purchase eligibilities of system customers.

### REFERENCE TO PRIOR APPLICATIONS

This application claims the benefit of U.S. Provisional Patent Application Ser. No. 62/627918, filed 8 Feb. 2018, and the benefit of U.S. Provisional Patent Application Ser. No. 62/724069, filed 29 Aug. 2018, both of which are incorporated by reference herein in their entirety.

### FIELD

The disclosed exemplary embodiments are directed to verifying customer identity and purchase eligibility within the legal cannabis industry.

### BACKGROUND

Large sums of money are being spent in cannabis dispensaries daily. The cannabis industry generated $6.7b in sales in the US in 2016, with industry analysts predicting 30+% CAGR over the next 5+years. This conservatively puts the US market at $20B annual sales in the next 2-3 years, none of which is bankable and almost exclusively cash. Despite the mounting acceptance and rapid growth of the cannabis industry, banking has remained the largest operational obstacle because of federal regulations. Cannabis entrepreneurs face a paradoxical operating environment where their enterprises are legal under state law and illegal under federal law, with which federally chartered banks comply. This also greatly impacts the ability of state regulatory bodies to determine revenue and use compliance across the industry.

The burden of keeping up with the ever-shifting federal and state regulations and compliance requirements for the cannabis industry, as well as other industries is complex can be overwhelming due to a lack of consistency or clarity across federal, state, county, and/or city laws and regulations. While the cannabis industry in particular struggles to best determine what legal requirements must be met, in particular with respect to Know Your Customer (KYC) controls for verifying the identity of clients and determining a client's propensity to violate banking regulations, other industries face a similar burden.

It would be advantageous to provide a system and method that overcomes these and other limitations of the prior art.

### SUMMARY

In at least one aspect, the disclosed embodiments are directed to a transaction and identity verification system including a processor, and a memory including computer program code, where executing the computer program code by the processor causes the transaction and identity verification system to utilize a private permissioned distributed ledger to qualify users for different capabilities within the system using a registration process, and verify identities and purchase eligibilities of the users.

In at least one additional aspect, the disclosed embodiments are directed to a method for verifying transactions and identities in a cannabis dispensary system including utilizing a private permissioned distributed ledger to qualify users for different capabilities within the system using a registration process, and verify identities and purchase eligibilities of the users.

In at least one further aspect, the disclosed embodiments are directed to a transaction and identity verification system including one or more nodes through which users may access facilities provided by the transaction and identity verification system, each node having a processor, and a memory including computer program code, where executing the computer program code by the processor causes each node of the transaction and identity verification system to register a user by verifying an identity of the user, creating a unique user identifier and a user record for the user, creating a smart contract to manage transactions involving the user, and publishing the unique user identifier, user record, and smart contract to a private distributed ledger.

In at least one still further aspect, the disclosed embodiments are directed to a method of verifying transactions and verifying user identities in a cannabis dispensary including using a node through which users may access facilities provided by the transaction and identity verification system to register a user by verifying an identity of the user, creating a unique user identifier and a user record for the user, creating a smart contract to manage transactions involving the user, and publishing the unique user identifier, user record, and smart contract to a private distributed ledger.

### BRIEF DESCRIPTION OF THE DRAWINGS

FIG. 1 shows a schematic illustration of an exemplary verification system according to the disclosed embodiments;

FIG. 2 illustrates an exemplary registration process for qualifying users;

FIG. 3 illustrates exemplary operations of a confidence scoring engine used during the registration process;

FIG. 4 illustrates an implementation of a smart contract utilized by the verification system;

FIG. 5 illustrates a process for adding a verified user identification and smart contract to a distributed ledger of the verification system;

FIG. 6 shows exemplary operations of a consensus engine used to confirm validity of additions to the distributed ledger;

FIG. 7A illustrates an exemplary dispensary registration process;

FIG. 7B illustrates exemplary confidence scoring operations used during a dispensary registration process;

FIG. 7C illustrates ongoing confidence scoring processes for the dispensary;

FIG. 7D shows a time of transaction verification process;

FIG. 7E illustrates exemplary operations used for confidence scoring operations used during the time of transaction verification process;

FIG. 8 illustrates a processing of a smart contract for determining transaction eligibility;

FIG. 9 illustrates the various transactions that may be performed by the smart contract of FIG. 8;

FIG. 10 shows the operation of a confidence scoring engine;

FIGS. 11 and 12 illustrate details of processing and storing a transaction on a distributed ledger;

FIGS. 13A-13D illustrate exemplary reports that may be provided from the distributed ledger for verified transactions;

FIG. 14 shows procedures for establishing relationships among dispensaries and financial institutions utilizing the verification system;

FIG. 15 illustrates an example of reports that may be provided to a financial institution having an established relationship with a dispensary;

FIGS. 16 and 17 show reports provided to financial institutions registered with the verification system;

FIG. 18 illustrates various permissions that may be assigned to different entities within the verification system;

FIG. 19 illustrates the use of channels for providing secure information flows between nodes of the verification system;

FIG. 20 illustrates permissions assigned to verification system users; and

FIG. 21 depicts an exemplary chain example and results.

### DETAILED DESCRIPTION

The aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

The disclosed embodiments are directed to a verification system for verifying customer identity and purchase eligibility within the legal cannabis industry that creates end to end transactional compliance records required to support access to financial institution services for dispensaries. While the disclosed embodiments are described in the context of the legal cannabis industry, it should be understood that the structures and techniques described herein may be applicable to any business that may be subject to government reporting requirements.

The following definitions are applicable for purposes of the disclosed embodiments:

A potential purchaser of cannabis products is referred to as a customer.

A customer, dispensary employee, financial institution or regulatory employee or stakeholder, or any person authorized to use the verification system is referred to as a user.

A user, including a customer, dispensary employee, financial institution or regulatory employee or stakeholder, that has been qualified and assigned a user unique identifier (UID) is referred to as a verified user, customer, dispensary employee, financial institution or regulatory employee or stakeholder, respectively.

A distributor or retail outlet of cannabis products is referred to as a dispensary.

Customers may register and verify their identity using the verification system that authenticates or verifies customers based on various electronic identity verification protocols. The verified customer may present their credentials for scanning at the time of purchasing legal cannabis and the verification system may evaluate the customer's data to determine whether or not the customer is eligible to complete the legal cannabis transaction. The dispensary may complete authorized transactions which in turn may be stored with the associated customer's record in the verification system, thereby creating an immutable view of each transaction that satisfies the applicable regulatory requirements associated with providing banking services to the cannabis industry. A confidence score may be calculated for various actions and transactions to enable real time identification of potentially fraudulent or malicious activity.

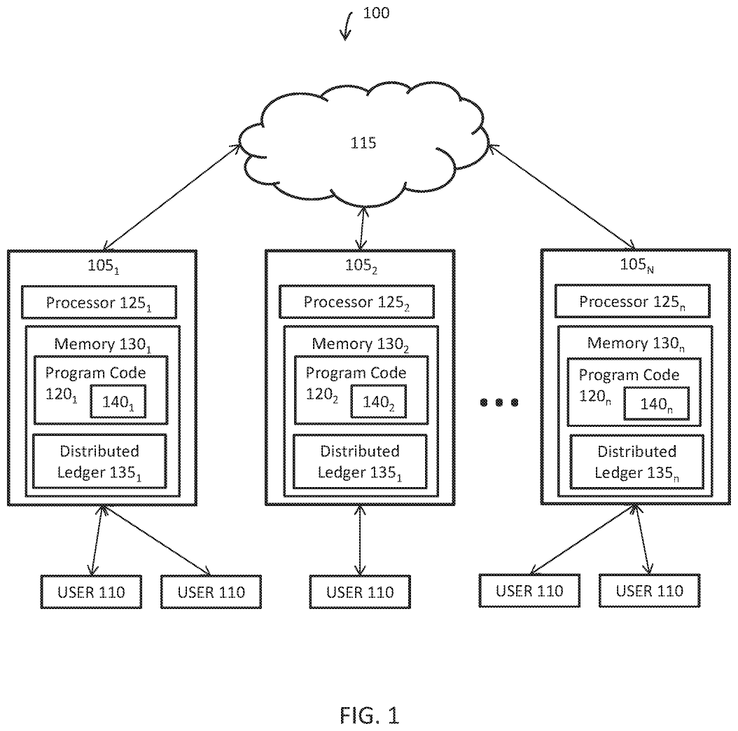

FIG. 1 shows a schematic illustration of an exemplary verification system 100 according to the disclosed embodiments. The verification system 100 may be distributed over one or more nodes 105₁-105ₙ through which users 110 may access the facilities provided by the verification system 100. The nodes 105₁-105ₙ may communicate through network 115. The verification system 100 may be configured as a cloud service, and implemented as one or more of software as a service, a platform as a service, and infrastructure as a service.

The nodes 105₁-105ₙ may include readable program code 120₁-120ₙ stored on at least one non-transitory computer readable medium for carrying out and executing the process steps described herein to effect a distributed verification system 140₁-140ₙ when executed by processors 125₁-125ₙ. The computer readable medium may include memories 130₁-130ₙ which may also store a distributed ledger 135₁-135ₙ. In alternate aspects, memories 130₁-130ₙ may be located external to, or remote from, nodes 105₁-105ₙ. Memories 130₁-130ₙ may include magnetic media, semiconductor media, optical media, or any media which is readable and executable by a computer.

The verification system 100 may utilize a private permissioned blockchain to create the distributed ledger 135₁-135ₙ and the distributed ledger 135₁-135ₙ may store relevant transaction information that may be shared among the nodes 105₁-105ₙ in a “read-only” capacity. The distributed ledger 135₁-135ₙ may be used to ensure each node 105 has the ability to validate transaction data that the node 105 receives according to an assigned permission level.

A block chain management application may add transactions to the distributed ledger 135₁-135ₙ using cryptographic techniques that ensure that no data can be manipulated once it has been added to the distributed ledger 135₁-135ₙ, thus giving the distributed ledger 135₁-135ₙ the properties of immutability and security that are vital to the verification system's objective of delivering transaction details needed to facilitate compliant banking of the cannabis industry.

The network 115 may provide the verification system 100 with access to any number of external or internal publicly or privately available databases, electronic data and identification verification systems, regulatory requirements databases, or any other data sources applicable to the disclosed embodiments.

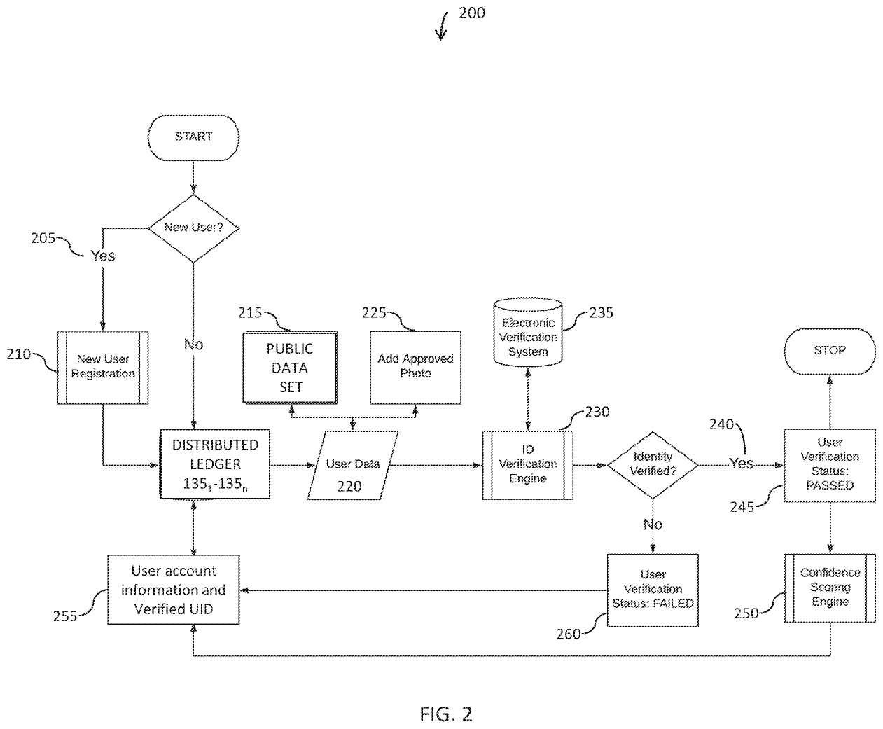

The verification system 100 may qualify users, including customers, dispensary employees, financial institution or regulatory stakeholders, or any persons authorized to use the verification system, using a registration process. An exemplary registration process 200 that may be used for qualification is illustrated in FIG. 2, but it should be understood that other suitable registration processes may be used. The registration process 200 may generally include verifying the identity of the user, creating an associated new user unique identifier, creating a new user record, creating a smart contract for transactions involving the user, and publishing the new user unique identifier and the smart contract to the distributed ledger 135₁-135ₙ of the verification system 100.

The verification system 100 may utilize various protocols for electronically verifying a user's identity. Users may create a user record 220 within the verification system and initiate an identity verification process by providing personally identifiable information about themselves. Upon establishing that a person accessing the registration process 200 is a new user 205, a new user registration process 210 may request, for example, personally identifiable information such as the user's email address, a password, phone number, date of birth, and address. The verification system 100 may generate transactions that search publicly available datasets 215 to verify the personally identifiable information, and may provide a code for entry into the user record 220 indicating that the supplied personally identifiable information is authentic.

The verification system 100 may also include a function for adding a user's photo 225 to the user record 220, including controlling a camera to capture and save a photo of the user. The verification system 100 may also use an ID verification engine 230 and an electronic verification system 235 to search publicly available datasets to locate the most probable match of the user's identity and may formulate a series of knowledge-based authentication (KBA) questions which the user must answer in order to verify their identity. The ID verification engine 230 and electronic verification system 235 may also generate transactions that reference the user's identity against a series of public and proprietary watch lists in order to confirm eligibility to purchase cannabis products and confirm already existing verification system credentials, if present.

Upon verification of the user's identity 240, the user may be designated a verified user and accorded a verification status of PASSED. In some instances, a confidence scoring engine 250 may be used to calculate a confidence score for the registration process using, for example, particular details of the registration process, results from the ID verification engine 230, the results of any risk assessments that may be available, and the completeness of the information gathered during the registration process.

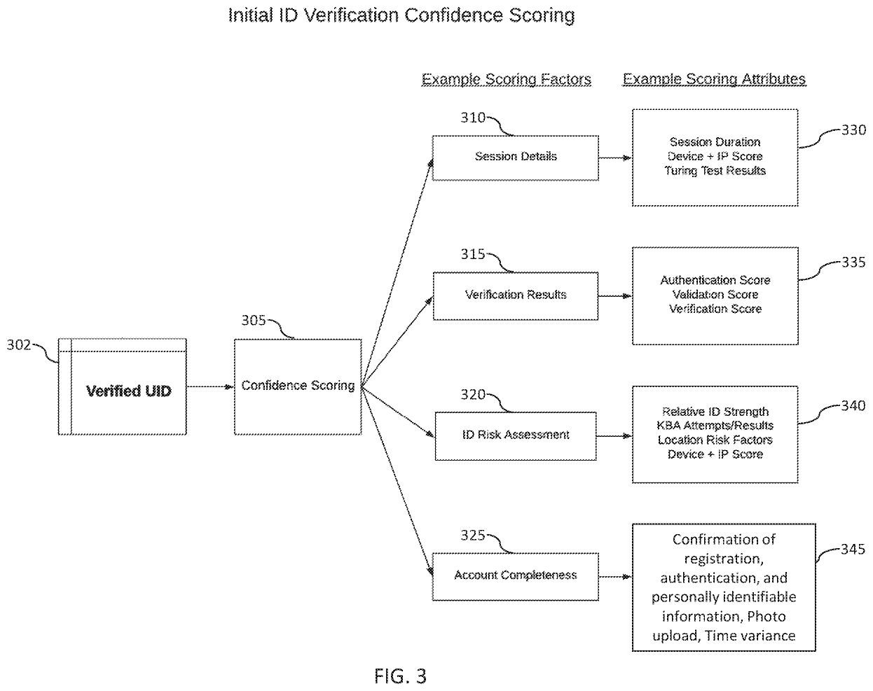

FIG. 3 illustrates exemplary operations of the confidence scoring engine 250 used during the registration process 200 upon generating a verified UID 302. The verification system 100 may generally perform a confidence score calculation at various transaction points. The resulting confidence score may establish a quantitative measurement for determining the veracity of the data being reported about each customer, dispensary, and transaction by aggregating a series of attributes related to the transaction in order to calibrate the probability of accurateness of the data associated with the transaction.

Furthermore, the calculated confidence score for each applicable transaction may be continuously recalculated to ensure that all actions, adjustments, factors, and rules are included in the real-time scoring of the data associated with each transaction. This continuous scoring mechanism enables instant identification of any potential fraudulent or malicious activity.

As shown in FIG. 3, the confidence scoring 305 used during the registration process 200 may use factors including for example, session details 310, verification results 315, ID risk assessment 320, and account completeness 325. Exemplary scoring attributes 330 for the session details factors 310 may include one or more of a service duration, a device and Internet Protocol (IP) score, related to the device sending unwanted bulk email, and Turing test results, related to how likely the entries made during the session are from a human. Exemplary scoring attributes 335 for the verification results factors 315 may include one or more of an authentication, validation, and verification score. Exemplary scoring attributes 340 for the ID risk assessment factors 320 may include one or more of a relative ID strength, a number of knowledge-based authentication attempts or results, one or more location risk factors, and the device and IP score. Exemplary scoring attributes 345 for the account completeness factors 325 may include one or more of a registration completion, authentication completion, confirmation of the personally identifiable information, whether or not a photo has been uploaded, and a time variance with respect to other users' registration completion times.

It should be understood that the example scoring factors and example scoring attributes may evolve over time in response to changing federal, state, and local regulations. At least one example of determining a confidence score may include four categories of example scoring factors as shown in FIG. 3. Each of the scoring factors: session details 310, verification results 315, ID risk assessment 320, and account completeness 325, may be assigned a total possible score determined by points assigned to the associated scoring attributes. The scores for the scoring factors may be tallied up to yield a total confidence score. In some embodiments, the total confidence score may be scaled to a percentage. For example:

Confidence Score=((session details+verification results+ID risk assessment+account completeness)/total available points100)*100.

Should the confidence score reach a certain pre-established threshold the transaction may receive a verification status of PASSED. If not, the transaction may receive a verification status of FAILED.

Returning to FIG. 2, upon achieving a verification status of PASSED, the user account information may be updated 255 by incorporating all the relevant information into the user account information 225, including a newly created verified unique identifier (UID), and storing the account information 225 in the distributed ledger 135₁-135ₙ. The verified UID may also be distributed among other users. In some exemplary embodiments, the verified UID may be a bar code or any other machine or human readable indicator. The verified UID may be distributed electronically using, for example, email, texting, or other suitable techniques.

In the event the user's identity cannot be verified, the user may be accorded a verification status of FAILED 260 and the results of the verification process may be stored in the user account information 225 and in the distributed ledger 135₁-135ₙ.

The verification system 100 may utilize blockchain “smart contracts” to invoke pre-programed business logic to be stored in user records 220 in the distributed ledger 135₁-135ₙ and executed during certain transactions. Smart contracts, as disclosed herein, may essentially comprise computer programs that serve as autonomous instructions to the block chain management application to determine which transactions are approved and therefore published to the distributed ledger 135₁-135ₙ. The smart contracts used in the distributed ledger 135₁-135ₙ may allow transaction eligibility to be determined for compliance purposes based on a number of factors, for example, factors concerning the customer, the dispensary, and the transaction in question. Each smart contract may be dynamic in the sense that a smart contract may be adaptable to the specific regulatory requirements of the environment in which it is executed.

Once associated with a verified customer, a smart contract may be invoked each time a dispensary begins a transaction with the verified customer by first verifying the authenticity and ownership of the customer's credentials, followed by the execution of the particular business logic in the smart contract, applicable to the particular transaction, that may be used to determine whether or not the transaction is eligible to be verified. Moreover, determining transaction eligibility using smart contracts may ensure that each of the nodes 105₁-105ₙ with access to the given transaction on the distributed ledger 135₁-135ₙ can maintain confidence in the conclusion and accuracy as to whether or not the transaction is compliant with applicable regulatory requirements, and therefore acceptable to a financial institution.

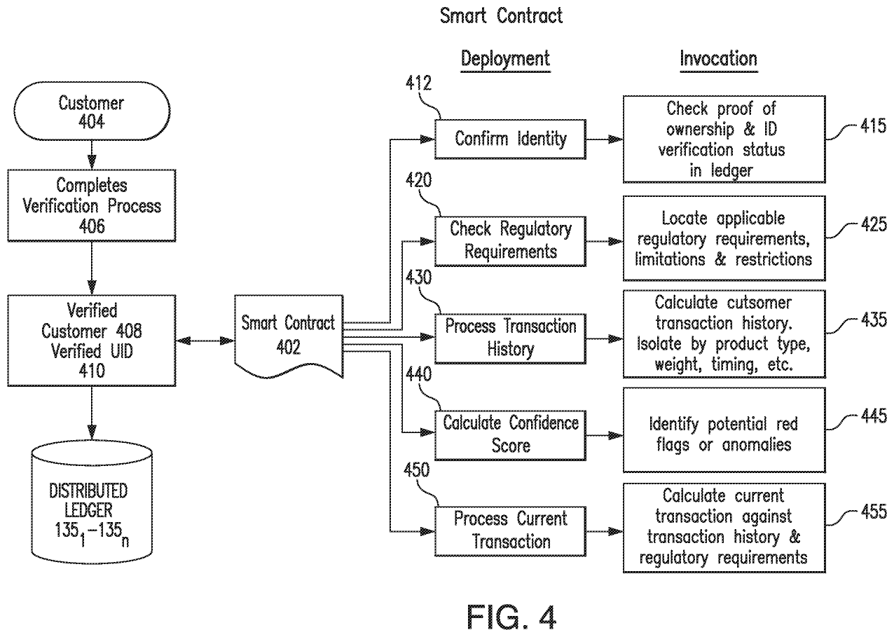

FIG. 4 illustrates a typical implementation of a smart contract 402 assigned to a customer 404, after completion of the verification process 406, that results in a verified customer 408 with a verified UID 410. In this implementation, the smart contract 402 may include logic to facilitate re-verification of the associated verified customer 408, logic to interpret and develop a verification system specific confidence score, and logic to process transaction eligibility. In particular, the smart contract 402 may include logic to confirm the identity of the verified customer 408 by at least confirming the customer's identity 412 by, for example, checking proof of ownership and the ID verification status in the distributed ledger 135₁-135ₙ, as shown in block 415, logic to generally check regulatory requirements 420 by at least locating applicable regulatory requirements, limitations, and restrictions 425 in any of the internal and external databases, logic to process the verified customer's transaction history 430 by at least retrieving the verified customer's transaction history from the distributed ledger 135₁-135ₙ, and identifying various product types, weights, timing of purchases, and other parameters that are part of the verified customer's transaction history, as shown in block 435, logic to calculate a confidence score for the present transaction 440 by identifying potential red flags or anomalies, as shown in block 445, and additional logic to process the current transaction 450 by at least comparing the current transaction against the verified customer's transaction history and regulatory requirements, as shown in block 455. The verified user ID 410 may be used to execute the smart contract 402 and may be stored in the distributed ledger 135₁-135ₙ.

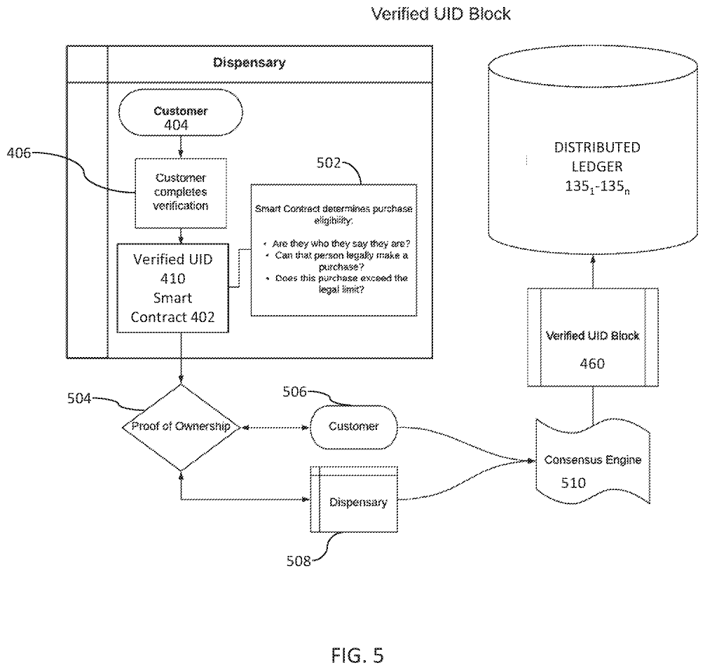

FIG. 5 illustrates an exemplary use of the verified ID 410 of FIG. 4, where the verified ID 410 and the smart contract 402 are added to the distributed ledger 135₁-135ₙ. The customer 404 may complete the registration process 406 at a dispensary and have a verified user ID 410 and smart contract 402 stored in the account information 225. As shown in block 502, the smart contract 402 may determine purchase eligibility based on the customer's verified user ID 410. A user ID proof of ownership 504 may be assigned to the customer's user record 506. A consensus engine 510 may be used to achieve consensus, and the verified UID 410, proof of ownership 504, and the smart contract 502 may be published to the distributed ledger 135₁-135ₙ.

In some embodiments, the proof of ownership 504 may be a public-private key pairing where a public key is assigned to the user record 506 and a user maintained private key is generated, upon the creation of the verified unique identifier (UID), and the storing of the UID and account information 225 in the distributed ledger 135₁-135ₙ as described with respect to FIG. 2. A proof of ownership process may be considered complete when the user provides the private key, and in combination with the public key, initiates a transaction. A record of the successful initial private key-public key pairing may be stored with the user account information. In some embodiments, the verification system 100 may utilize the record of the successful initial pairing to track the number of customers being successfully verified at each dispensary.

In order to achieve decentralized confirmation of the validity of each addition to the distributed ledger 135₁-135ₙ, the verification system 100 may gather consensus across a limited number of the nodes 105₁-105ₙ prior to updating the distributed ledger 135₁-135ₙ. Consensus may be achieved by using the consensus engine 510 to perform algorithmic processes that confirm the completion, correctness, and state of any newly proposed transaction. The verification system's block chain management application may provide for a modular consensus approach that includes three phases: endorsement, ordering, and validating.

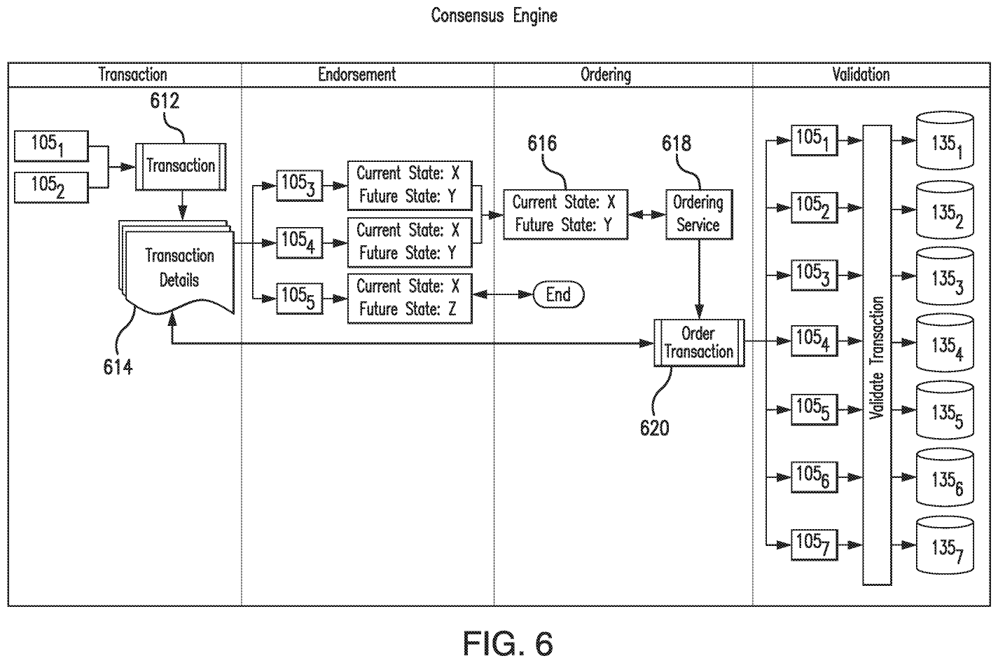

Exemplary operations of the consensus engine 510 are shown in FIG. 6, in the context of an exemplary verification system with 7 nodes 105₁-105₇. In this example, a transaction 612 occurs between nodes 105₁ and 105₂ and the consensus engine 510 provides the transaction details to nodes 105₃, 105₄, and 105₅ for endorsement. The endorsement phase performed by the consensus engine 510 may be an algorithmic process in which a limited number of nodes 105 of the verification system 100 deduce the current state/value(s) of the distributed ledger 135₁-135ₙ and simulate completion of the proposed transaction in order to identify the changes that would be made to the distributed ledger 135₁-135ₙ if the transaction were to be executed. A predefined subset of the limited number of nodes must arrive at the same current distributed ledger state and simulated future distributed ledger state in order for the transaction to be endorsed. The consensus engine 510 may include a pre-defined endorsement policy that dictates the number and type of nodes that need to endorse each transaction type before it can proceed. As shown in FIG. 6, agreement between two nodes may be required for endorsement, and nodes 105₃ and 105₄ have determined the same current state X and the same simulated future state Y, while node 105₅ has not. As a result, the transaction 616 in the form of the determined current state and simulated future state may considered to be endorsed.

The endorsed transaction 616 may be provided to an ordering service 618 of the consensus engine 510, which may order the transaction 616 with other transactions in a block 620 to be broadcast to all of the permissioned nodes 105₁-105₇ which share the distributed ledger 135₁-135₇. The broadcast may include the full transaction details, as well as the current and future state values that were agreed upon in the endorsement phase.

The nodes 105₁-105₇ may then operate to validate the transaction by comparing each of their own current distributed ledger state with the current distributed ledger state that was endorsed and broadcast. Each node 105₁-105₇ may only publish the transaction to its respective distributed ledger 135₁-135₇ upon validation.

The endorsement, ordering, and validation phases may operate autonomously without any user input or attention. Each node 105₁-105₇ may simply serve as a computational entity that independently executes the applicable functions in order to achieve consensus.

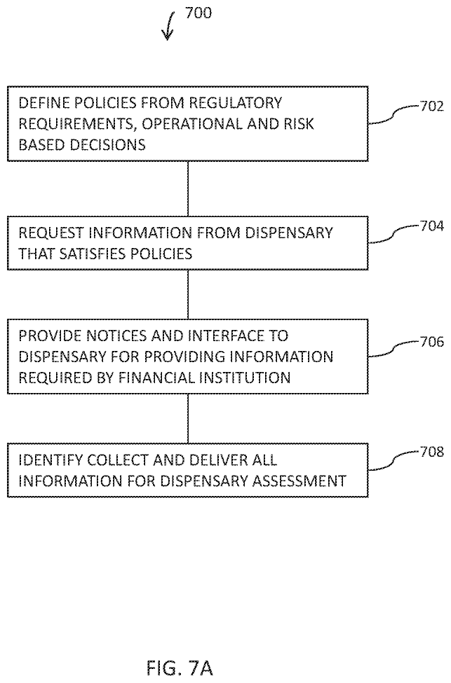

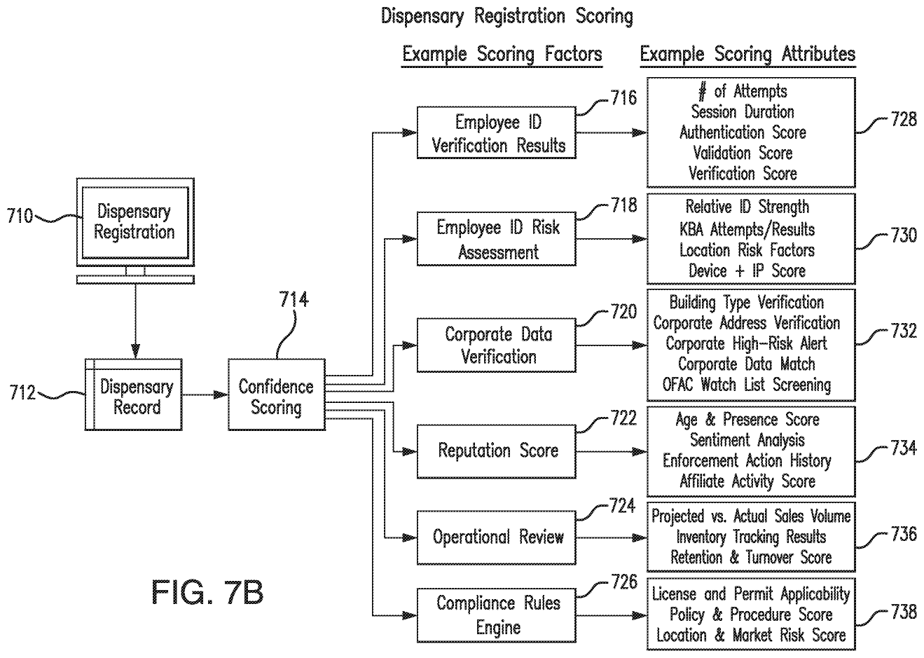

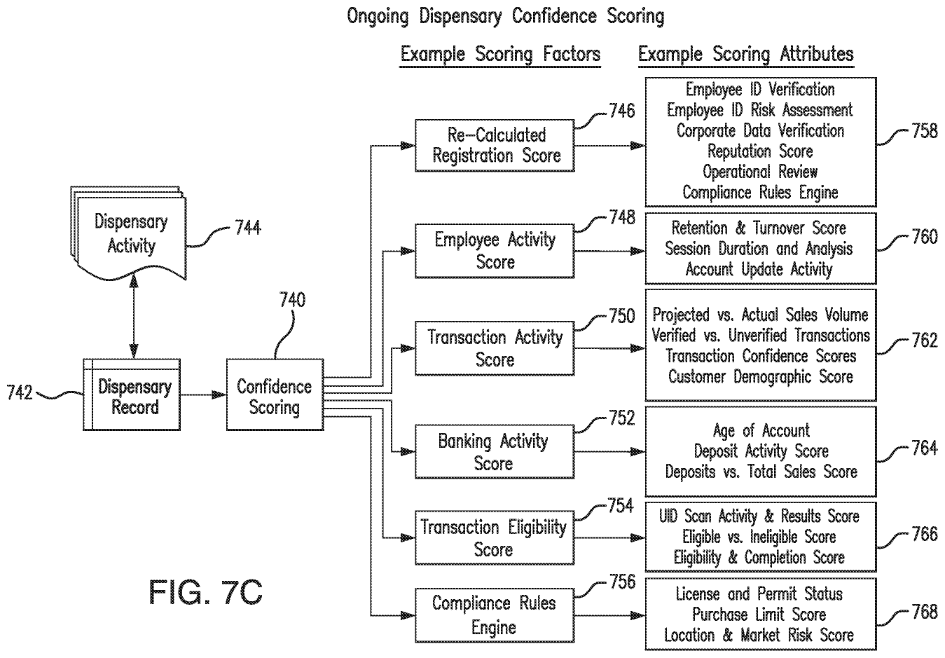

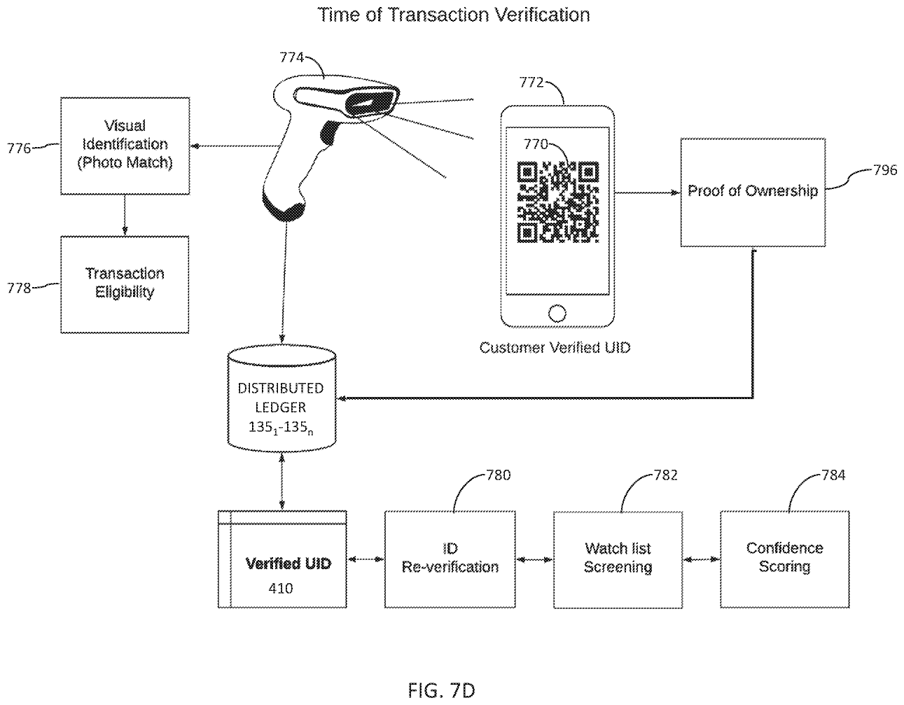

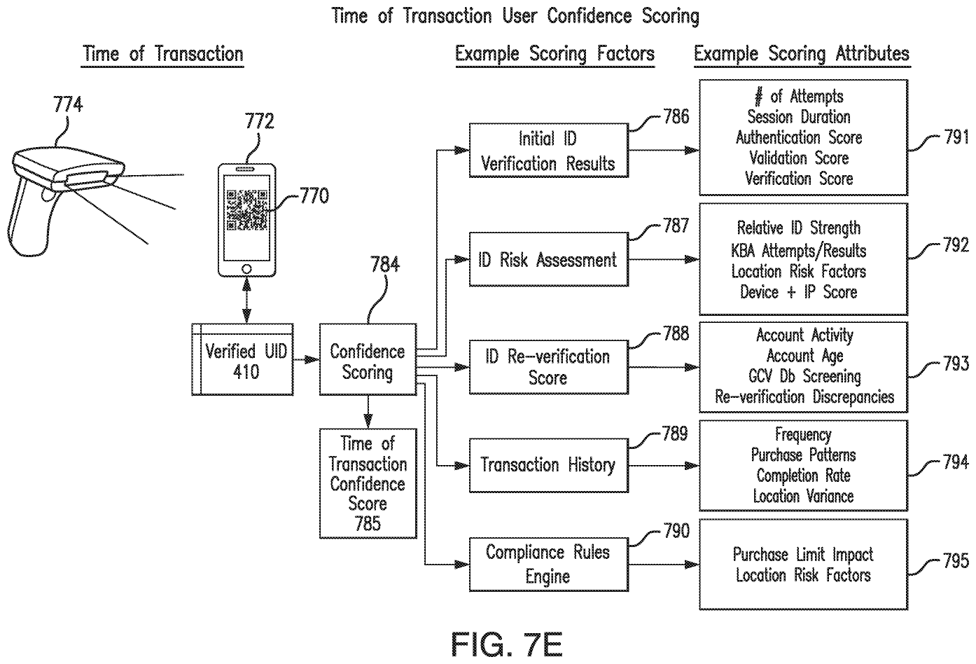

An exemplary dispensary registration process 700 is illustrated in FIG. 7A. The registration process 700 may generally include defining financial institution policies from regulatory requirements, and from operational risk based decisions by the financial institution, as shown in block 702. The verification system 100 may then request information from the dispensary that satisfies the policies as shown in block 704, and may provide various notices to the dispensary and an interface to allow dispensary to provide the required information, as shown in block 706. The verification system 100 may operate to identify, collect, and deliver all the information for assessment to the financial institution, as shown in block 708.

FIG. 7B illustrates exemplary confidence scoring operations that may be used when a dispensary 710 registers with the verification system 100. The dispensary registration process may include constructing a dispensary record 712 that may be published to the distributed ledger 135₁-135ₙ. The dispensary record 712 may include any number of dispensary characteristics, for example, user account information and verified UlD's of dispensary personnel who have completed the registration process 200, and dispensary corporate information. The dispensary corporate information may include, for example, business address, business age, enforcement action history, license and permit information, information collected when customers are verified by the registration process, and any other business related information. As mentioned above, the verification system 100 may generally perform a confidence score calculation at various transaction points. As shown in FIG. 7B, the confidence scoring operation 714 used during the dispensary registration process may use factors including for example, employee ID registration results 716, employee risk assessments 718, corporate data verification results 720, a dispensary reputation score 722, a dispensary operational review 724, and an output from a compliance rules engine 726.

The compliance rules engine 726 may operate a sophisticated algorithm that may ingest the details of a sales transaction and checks the details against an extensive set of rules that may include federal, state, local, and financial institution requirements governing a transaction. The compliance rules engine may leverage a combination of boolean rules (i.e. True/False as in “this sale was made to a customer 18 years of age or older”) and machine learning features that may identify trends of potentially suspicious behavior that might prohibit a sale from passing a verification check. Each rule may be assigned a numerical score, and that total score when calculated may determine a total by which the compliance rules engine determines whether the transaction meets the minimum requirements determined by the verification system 100 and the associated financial institution.

Exemplary scoring attributes 728 for the employee ID registration results 716 may include one or more of a number of registration attempts, a service duration, an authentication score, a validation score and a verification score. Exemplary scoring attributes 730 for the employee risk assessments 718 may include one or more of a relative ID strength, a number of knowledge-based authentication attempts or results, one or more location risk factors, and a device and IP score. Exemplary scoring attributes 732 for the corporate data verification results 720 may include one or more of a building type verification, a corporate address verification, a corporate high risk alert, and a corporate data match on an Office Of Foreign Assets Control watch list. Exemplary scoring attributes 734 for the reputation score 722 may include one or more of an age and presence score, a sentiment analysis, an enforcement action history, and an affiliate activity score. Exemplary scoring attributes 736 for the operational review 724 may include one or more of a projected versus actual sales volume, inventory tracking results, and a retention and turnover score. Exemplary scoring attributes 738 for the compliance rules engine 726 may include one or more of a license and permit applicability, a policy and procedure score, and a location and market risk score.

Once registered, a dispensary may be subject to ongoing confidence scoring which may occur on a periodic basis or upon request of an associated financial institution, as illustrated in FIG. 7C. The confidence scoring 740 used during the ongoing dispensary confidence scoring process may be applied to any suitable record 742 of dispensary activity 744, and may use factors including for example, a re-calculated registration score 746, an employee activity score 748, a transaction activity score 750, a financial institution activity score 752, a transaction eligibility score 754, and a compliance rules engine output 756. Exemplary scoring attributes 758 for the re-calculated registration score 746 may include one or more of an employee ID verification, an employee risk assessment, a corporate data verification, a reputation score, an operational review and a compliance rules engine. Exemplary scoring attributes 760 for the employee activity score 748 may include one or more of a retention and turnover score, a session duration and analysis, and account update activity. Exemplary scoring attributes 762 for the transaction activity score 750 may include one or more of projected versus actual sales volume, verified versus unverified transactions, transaction confidence scores, and customer demographic scores. Exemplary scoring attributes 764 for the banking activity score 752 may include one or more of an age of an account, deposit activity score, and deposits versus total sales score. Exemplary scoring attributes 766 for the transaction eligibility score 754 may include one or more of a UID scan activity and results score, an eligible versus ineligible score, and an eligibility and completion score. Exemplary scoring attributes 768 for the compliance rules engine 756 may include one or more of a license and permit status, a purchase limit score and a location and market risk score.

Once established in the distributed ledger 135₁-135ₙ as a verified customer with a verified UID, the verified customer may retrieve their verified UID 770 in order to effect a purchase at a dispensary using a time of transaction verification process as shown in FIG. 7D.

The verified customer may retrieve the verified UID 770 by logging in to the verification system 100 and displaying the verified UID 770, for example, in the form of a bar code. The verified customer may access the verification system 100 through a mobile device, a desktop device, a kiosk, or any suitable device 772 provided by the verified customer, the dispensary, or other authorized channel for securely retrieving credentials. The dispensary may have a scanner or other facility for scanning or otherwise reading the verified customer's UID 770. For example, dispensary personnel may have an interface to the verification system 100 open on a point of service terminal and may proceed to scan the customer's verified UID using an existing scanning device 774 as part of the point of service terminal.

Upon scanning the verified customer's UID 770, the interface to the verification system 100 may display the photograph 225 of the verified customer and the dispensary staff may conduct a visual comparison 776 of the customer and the photograph associated with the verified customer's UID 770 to determine transaction eligibility 778. The customer may complete a proof of ownership process 796 by completing a successful private key-public key pairing, and the verification system 100 may conduct an ID re-verification 780 by requesting the customer's personally identifiable information and comparing the provided personally identifiable information with the user record 220 associated with the customer's UID 770. The verification system 100 may review public and proprietary watch lists 782 and may calculate a time of transaction confidence score 784.

FIG. 7E illustrates exemplary operations that may be used for the confidence scoring operations 784 used during the time of transaction verification process for producing a time of transaction confidence score 785. The confidence scoring operations 784 may utilize exemplary factors including initial ID verification results 786, ID risk assessment 787, ID re-verification score 788, transaction history 789, and results from a compliance rules engine 790. Exemplary scoring attributes 791 for the initial ID verification results 786 may include one or more of a number of attempts, a service duration, an authentication score, a validation score and a verification score. Exemplary scoring attributes 792 for the ID risk assessment 787 may include one or more of a relative ID strength, a number of knowledge-based authentication attempts or results, one or more location risk factors, and a device and IP score, as explained above. Exemplary scoring attributes 793 for the ID reverification score 788 may include one or more of an account activity, account age, database screening, and reverification discrepancies. Exemplary scoring attributes 794 for the transaction history 789 may include one or more of frequency purchase patterns, a completion rate, and a location variance. Exemplary scoring attributes 795 for the compliance rules engine 790 may include one or more of a purchase limit impact and location risk factors.

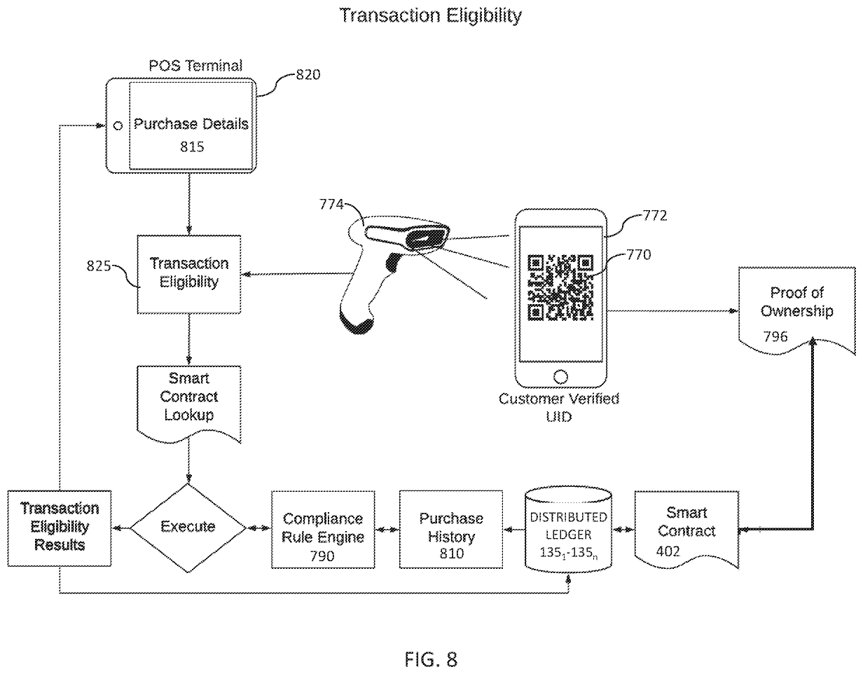

Upon successful re-verification, the verification system 100 may then calculate transaction eligibility 778 as shown in detail in FIG. 8, by processing the terms of the customer's smart contract 402. The customer's smart contract logic 402 may calculate a desired purchase amount/concentration against local regulatory guidelines, and may take into account historic purchases 810 made by the customer within the required time windows of the local regulations and other parameters that might be specified by the customer, regulatory authorities, or the dispensary. Transaction eligibility may be further calculated based on an existing confidence score, determined by the compliance rules engine 790, associated with the user account information 225. Calculating transaction eligibility may further include processing proof of ownership 796, opening the user's smart contract 402 and populating the smart contract terms with the parameters of the current purchase, isolating controlled substance products and calculating product conversions, such as weights and concentrations.

As shown in FIG. 8, information 815 about a customer's purchase may be entered into a point of sale terminal 820 and the customer's UID 770 may be scanned using a scanning device 774. The verification system 100 may use the proof of ownership process 796 described above to confirm that the scanned UID 770 is associated with the verified identity record presented within the scanned UID 770. The verification system 100 may then return the results of the proof of ownership process to confirm that the scanned UID 770 is a verified UID. The verification system may then access the purchase history 810 associated with the user record to determine transaction eligibility 825 according to all applicable regulatory requirements and financial institution policies, and may return transaction eligibility results to confirm whether or not the transaction is in compliance with the applicable regulatory requirements and financial institution policies.

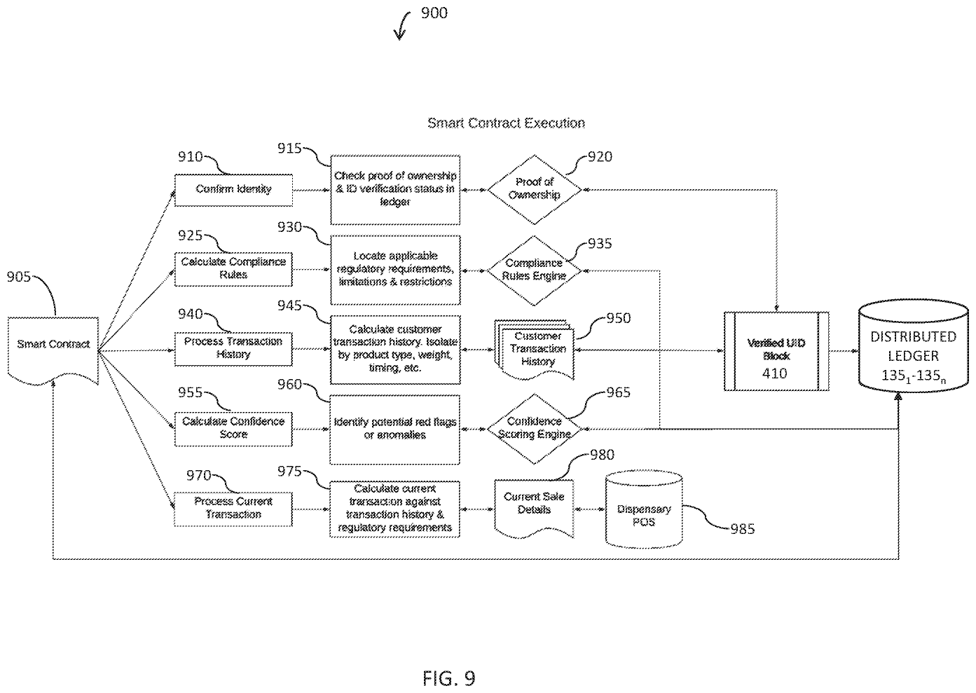

FIG. 9 illustrates the various transactions that may be performed by the execution 900 of the smart contract of FIG. 8. When the smart contract 905 is initiated, the smart contract may confirm the identity of the customer 910 by checking proof of ownership and the customer's ID status in the distributed ledger 135₁-135ₙ, 915 by accessing the Proof of Ownership records 920. The smart contract 905 may calculate a compliance rules score 925 by using the compliance rules engine 935 to locate applicable regulatory requirements, limitations, and restrictions 930. The smart contract 905 may also operate to process the transaction history 940 by calculating the customer transaction history, isolating the transactions by product type, product weight, purchase timing, or other parameters 945, using information from the customer's transaction history 950. The customer's transaction history 950 may be extracted from distributed ledger 135₁-135ₙ using the verified UID 410. The smart contract 905 may further use the confidence scoring engine 965 to calculate a confidence score 955 in order to identify any potential red flags or anomalies 960. The smart contract 905 may still further operate to process the current transaction 970 by calculating the current transaction against the customer's transaction history and regulatory requirements 975 using the current sales details 980 obtained, for example, from the dispensary point of sale terminal 985.

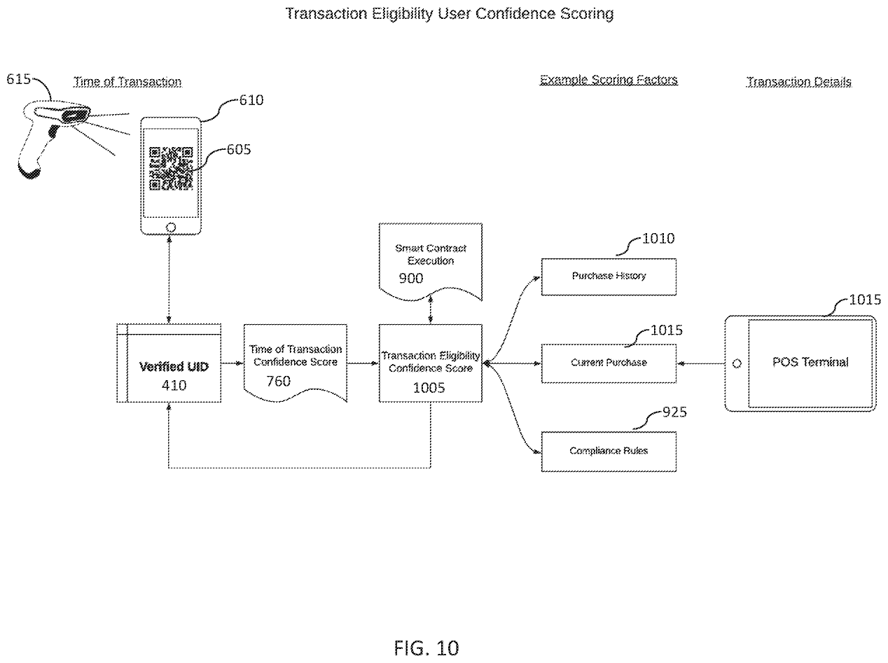

The operation of the confidence scoring engine 965 of FIG. 9 is shown in FIG. 10. As part of the execution 900 of the smart contract, the confidence scoring engine 956 may operate to calculate a transaction eligibility confidence score 1005 using the time of transaction confidence score 760 from the customer's purchase history 1010, the details of the current purchase 1015 from a point of sale terminal 1015, and the compliance rules score 925 calculated as part of the smart contract execution.

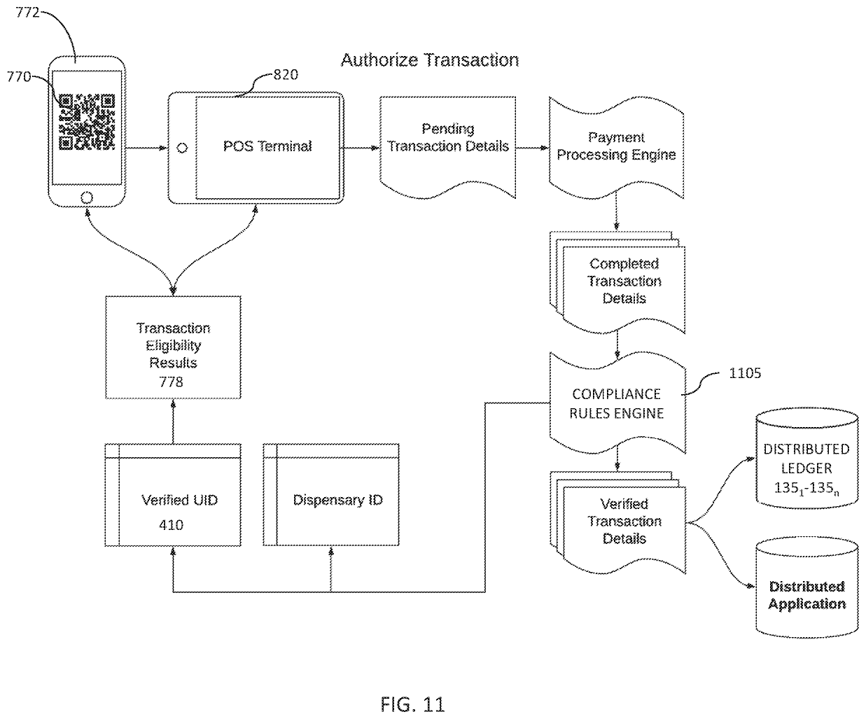

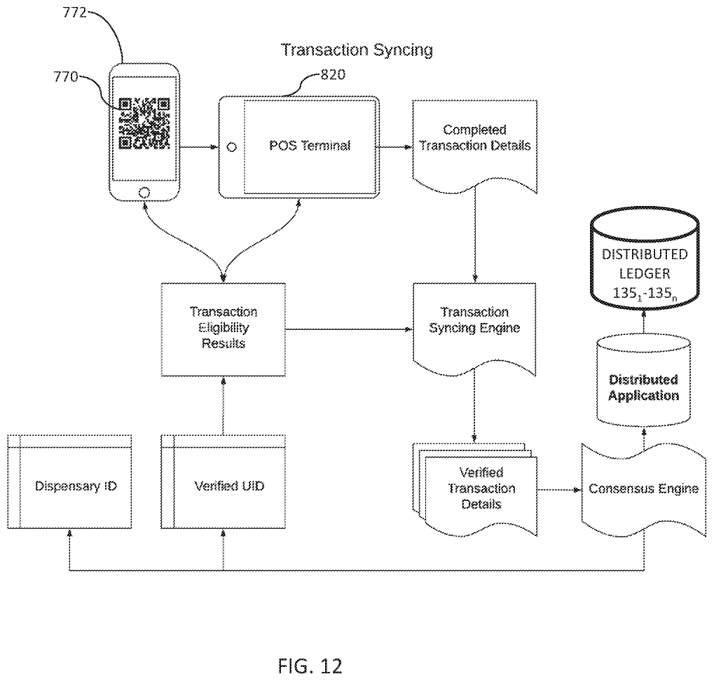

With the customer's identity verified and the details of the transaction deemed eligible under applicable regulatory guidelines, the dispensary may process the customer's form of payment and verify the transaction. Once complete, the full transaction details may be processed and stored on the distributed ledger 135₁-135ₙ in the form of a verified transaction. The details of processing and storing the transaction on the distributed ledger 135₁-135ₙ are shown in FIGS. 11 and 12, which illustrate the process by which the verification system 100 may use a customer's verified identity 410 to determine whether a transaction may be completed based on previous a purchase history. A customer's identity may be entered in the point of sale terminal 820, for example, by scanning a barcode 770 on a device 772 such as a smartphone, and the verification system 100 may return the customer's transaction history stored in the distributed ledger 135₁-135ₙ. The compliance rules engine 1105 may apply a verification process, and if the transaction history precludes the transaction from being completed, the customer may be notified through the point of sale terminal 820. A successful transaction may be recorded and added to the customer's purchase history in the distributed ledger 135₁-135ₙ, which may be used again to verify the next attempted transaction. FIG. 12 illustrates a process by which transactions may be synchronized.

The verification system 100 may be specifically configured to accommodate the requirements of financial institutions and to register financial institutions as users. In particular, financial institutions may establish relationships with compliant dispensaries by using a double opt-in sequence that allows both parties to authorize the relationship. By establishing a relationship and authenticating the appropriate financial institution employees, the financial institution may be able to use the verification system 100 to access real time information pertaining to the dispensary's transactional compliance.

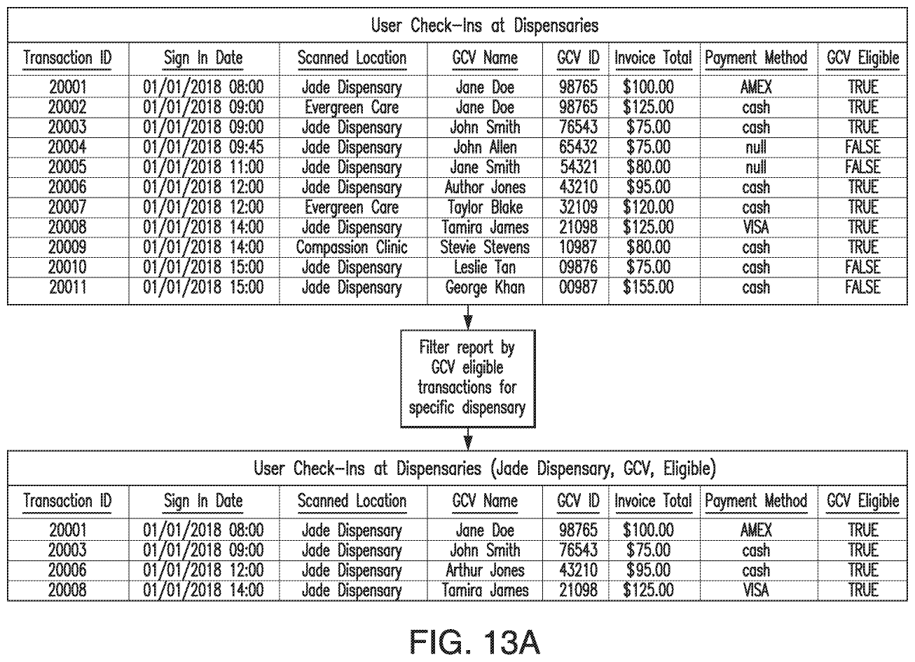

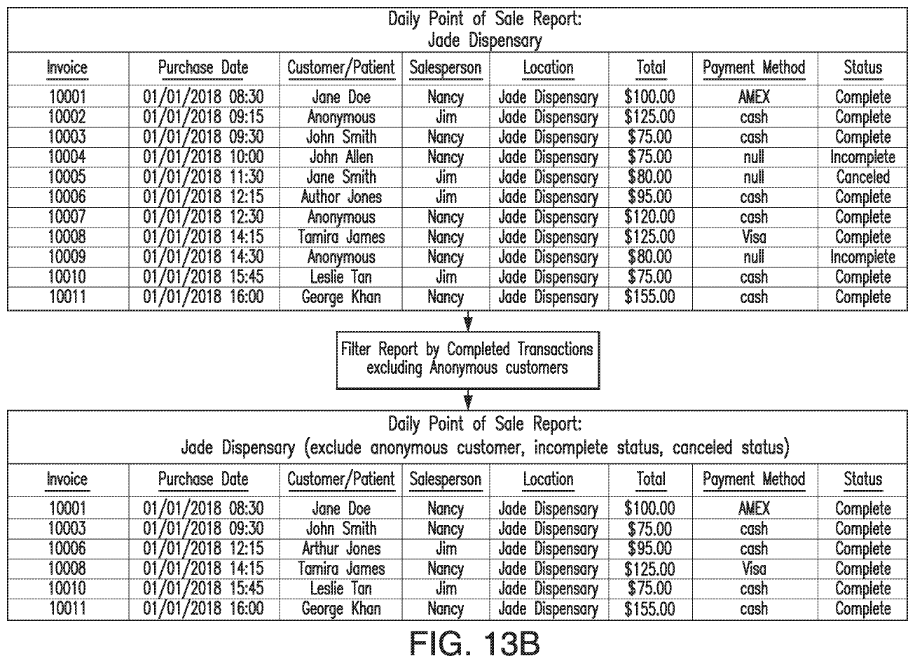

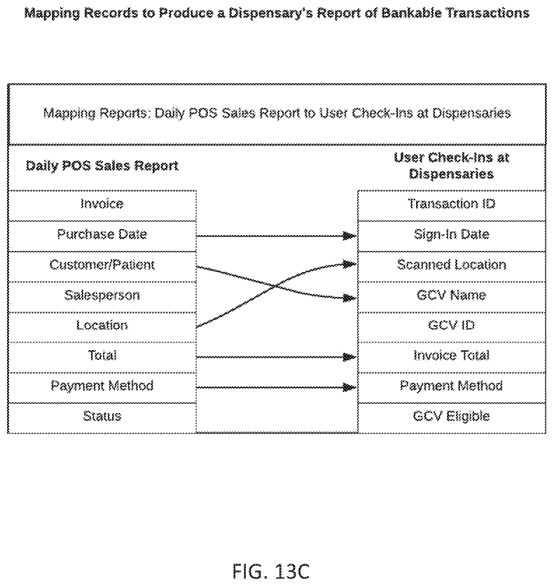

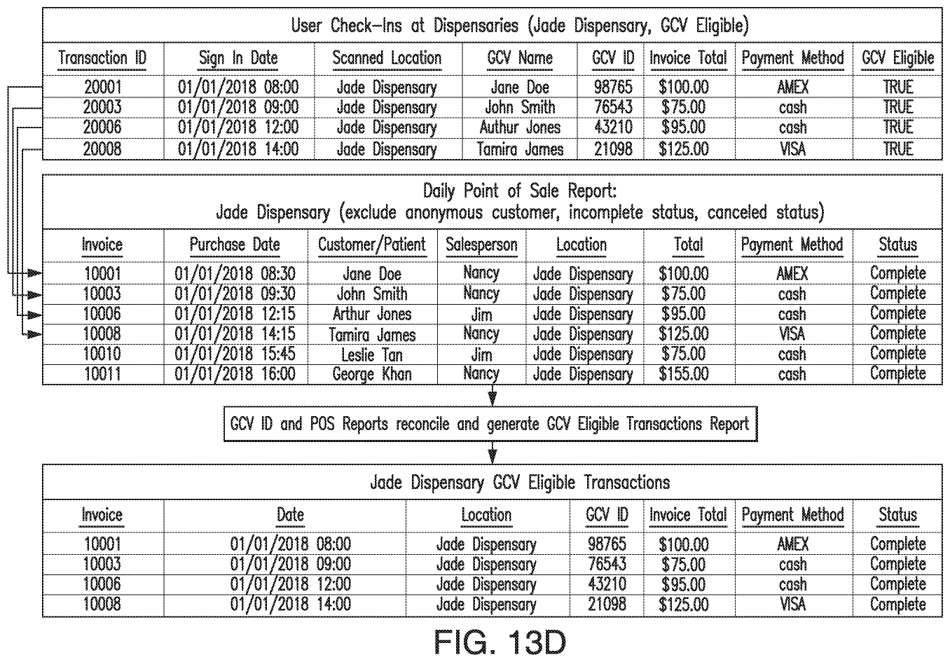

The dispensary information made available to the financial institution may include relevant data needed to facilitate ongoing monitoring processes associated with offering financial services to a dispensary, as well as any applicable regulatory reporting requirements. Exemplary reports are shown in FIGS. 13A-13D. In some embodiments, the reports may be used to support Financial Crimes Enforcement Network (FinCEN) reporting requirements, for example, to document sources of funds as being derived from legal complaint transactions.

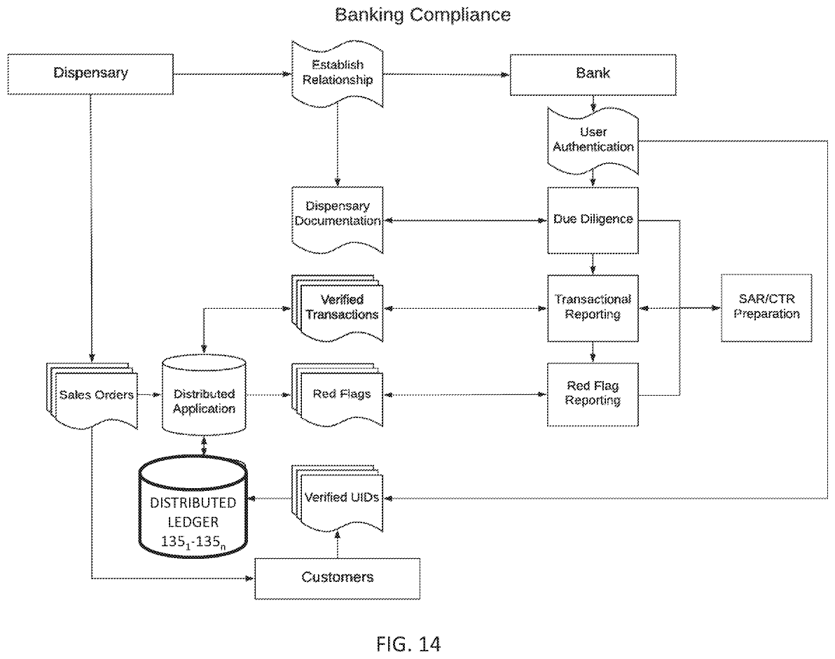

FIG. 14 illustrates an exemplary banking compliance procedure. Banks looking to establish relationships with compliant dispensaries are able to do so using a double opt-in sequence that allows both parties to authorize the relationship. By establishing a relationship and authenticating the appropriate bank employees, the bank is then able to use a web application to access real time information pertaining to the dispensary's transactional compliance. The dispensary information being reported to the bank includes all relevant data needed to facilitate the ongoing monitoring processes associated with offering banking services to a dispensary, as well as the applicable regulatory reporting requirements. Establishing the relationship may include a dispensary authentication and a bank authentication and a review of confidence scores. A bank onboarding and due diligence procedure may include user authentication, a document retrieval, a transaction archive review, and a configuration of a reporting regimen. Transactional reporting may be enabled by establishing a scheduled delivery, a proof of authenticity, and a proof of consensus.

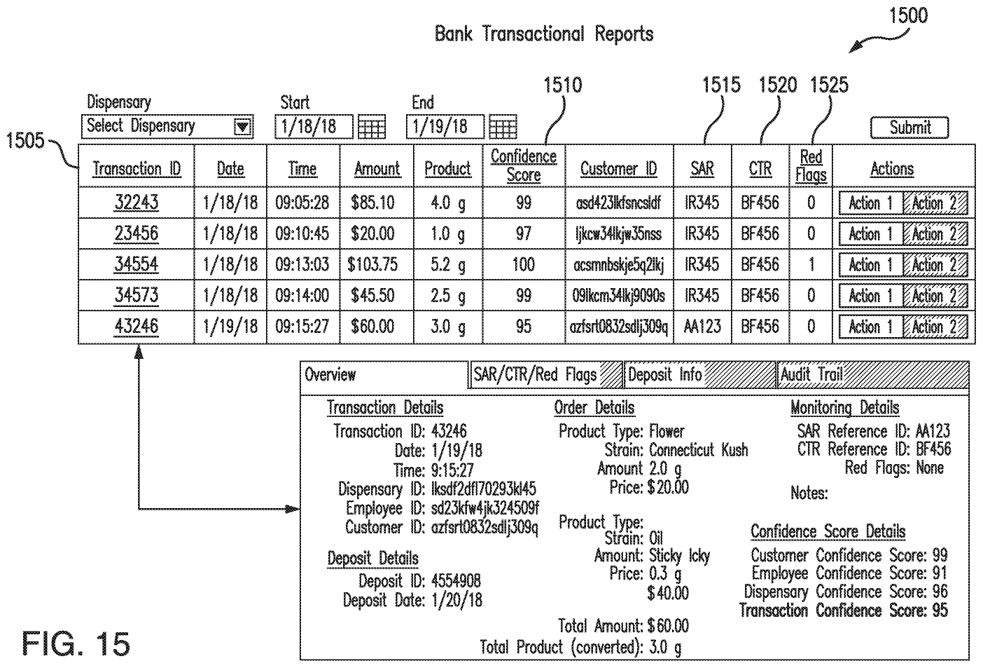

FIG. 15 illustrates an example of reports 1500 that may be provided to a financial institution having an established relationship with a dispensary. The reports may include a listing of transactions 1505 including a confidence score 1510, any Suspicious Activity Reports (SARs) 1515, Currency Transaction Reports (CTRs) 1520, or red flag indications 1525. The reports illustrated in FIG. 15 may also be used to support FinCEN reporting requirements, for example, to document sources of funds as being derived from legal compliant transactions. In addition, these reports may also be used to support a financial institution's processes for monitoring account activity and reporting potentially suspicious activities commensurate with the Bank Secrecy Act, Anti Money Laundering, and Office of Foreign Access Control guidelines.

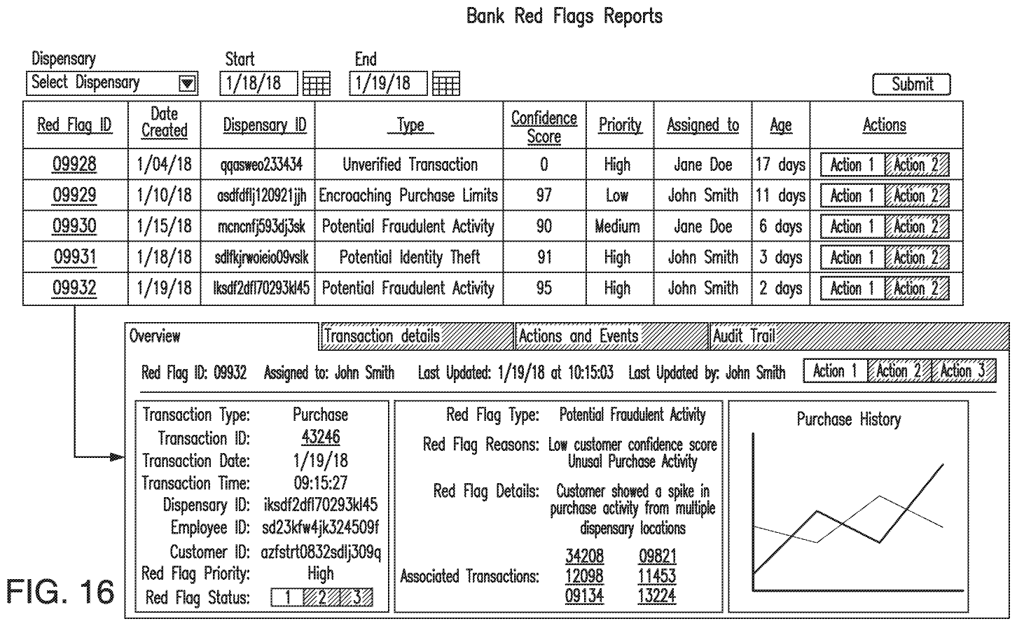

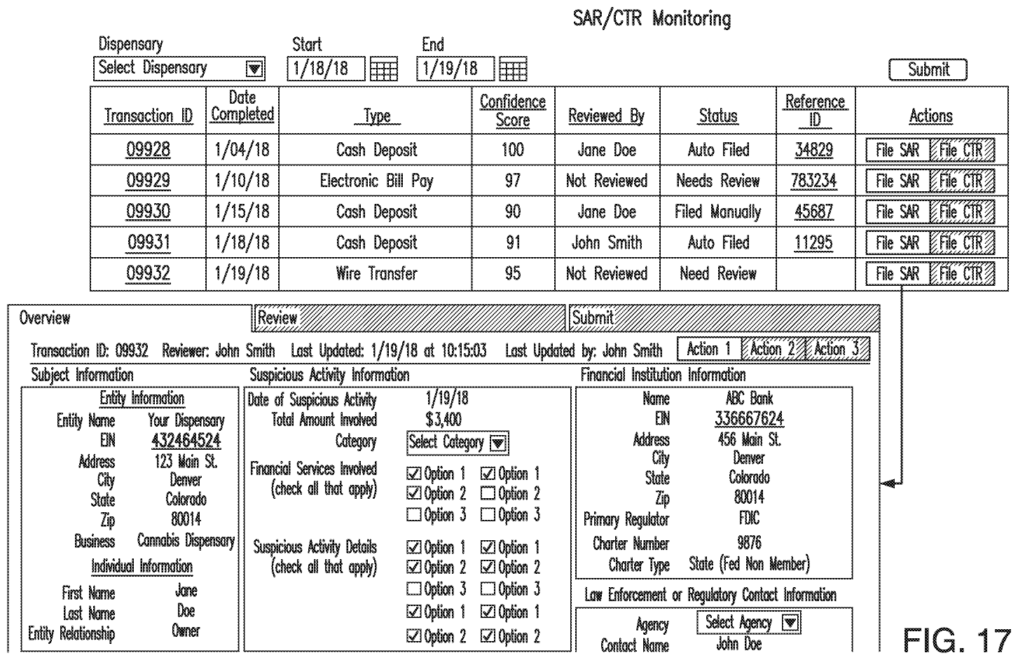

The verification system may also provide financial institutions with red flag reports as shown in FIG. 16 and various SAR and CTR reports as shown in FIG. 17.

The verification system 100 also provides users with access to current and historical details pertaining to their usage of the platform. The structure and availability of the reporting frameworks respects the permissions set for each node in the verification system. Current and historical details may be selectively provided depending individual user's operating functions within the verification system. While various examples of different types of reports are detailed below, it should be understood that any of the information stored in the verification system may be extracted into any suitable report in any suitable report format. Furthermore, it should be understood that the reported data may be presented in the form of various dashboards, where pertinent data may be consolidated and displayed together, and may be updated periodically or in real time.

For example, a verification system administrator may be provided details regarding dispensary activity, user activity, verified transactions, confidence scores, red flag, error, and failed verification reports, and audit logs.

As another example, a dispensary administrator may be provided with details regarding employee transaction history, verified transactions, and red flag, error, and failed verification reports. The dispensary administrator may be also be provided with dispensary predictive analytics including a predictive analytics dashboard, cost savings opportunities based on verified customers versus non-verified customers, revenue generation activities, and regulatory guideline applicability to various activities.

As a further example, customers may be provided with transaction history and audit log reports.

Registered financial institutions may be provided with, for example, compliance reports, transaction reports, red flag reports, SAR/CTR reports, and dispensary documentation (permits, licenses, business plans, pro formas, etc.).

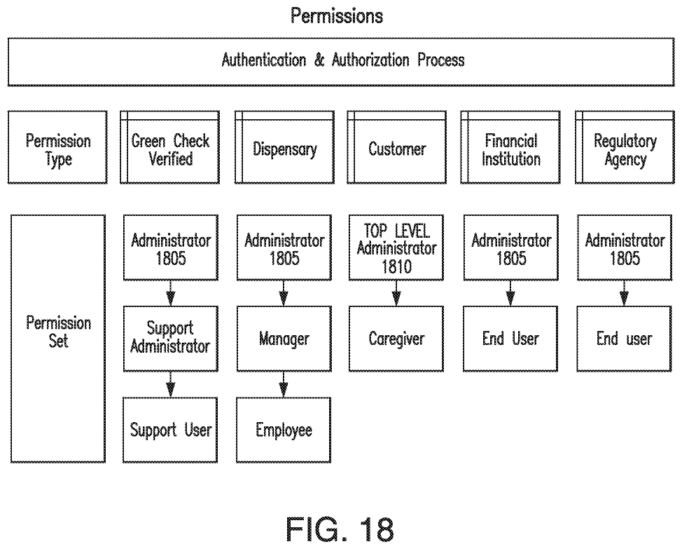

As mentioned above, the verification system is implemented as a permissioned network, meaning that each node requires an authorized and authenticated identity in order to access the distributed ledger 135₁-135ₙ. The authorization level may be determined based on the identity type, identity confidence score, and identity use cases. The usage and characteristics of the permissions of each node within the verification system 100 are set and maintained by the verification system 100 as the authoritative entity. FIG. 18 illustrates various permissions that may be assigned to different entities within the verification system 100. Administrators 1805 and Top Level End Users 1810 may provide a subset of the permissions to lower level entities. The permissions may be created and assigned using a rule based access method that allows or restricts access to certain aspects of the verification system 100, for example, application pages, reports, or functionalities. Every component of the verification system 100 may have an assigned permission assigned, for example, active tasks such as approving a form, uploading a due diligence document, updating a personal profile, or passive tasks, such as viewing a compliance document or viewing activities performed by other users. As user profiles are built for dispensaries, customers, and financial institutions, each profile may be assigned a certain subset of those permissions based on system access required to complete assigned responsibilities. These profiles may vary, for example, based on scale of business, state and local regulations, and financial institution policies, however there may generally be an Administrator role who may have access to a greater number of permissions, including the ability to create other users and assign predefined roles to their accounts.

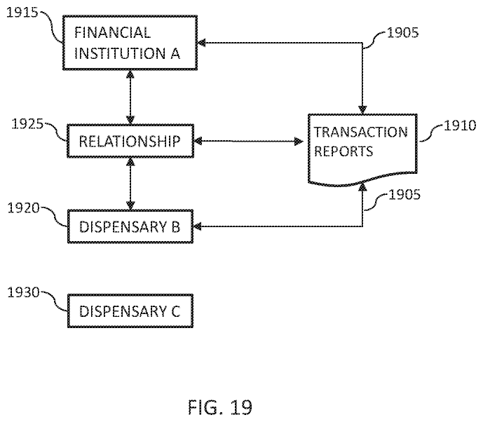

Referring to FIG. 19, the verification system 100 may utilize channels 1905 to allow information 1910 to securely flow between two interacting nodes 1915, 1920 on the network. A channel 1905 may represent an information path that may establish one or more gateways and boundaries between nodes, thus ensuring proper access to data that each node shares with one or more other nodes. Each node 1915, 1920 may initiate a relationship 1925 that may define types and amounts of data and sharing parameters. For example, financial institution A 1915 may be able to access the real time transaction reports 1910 from dispensary B 1920 if financial institution A 1915 and dispensary B 1920 have established a relationship 1925, however financial institution A 1915 would not be able to access the same reports from dispensary C 1930 because there is no established relationship.

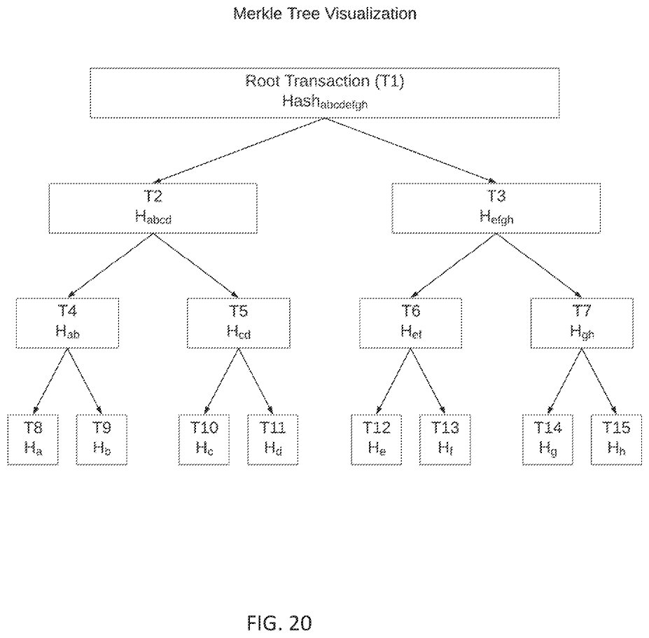

Referring to FIG. 20, the verification system 100 provides the permissioned users with views for validating, reviewing, and searching for completed transactions. These views contain the information needed to independently verify the accuracy and completeness of each verified transaction, as well as provide insight into non-verified transactions thus creating a singular view of all sales activity of a given dispensary, or set of dispensaries that a bank has partnered with. One or more views may include block chain auditing using chain visualization, for example, using a Merkle tree.

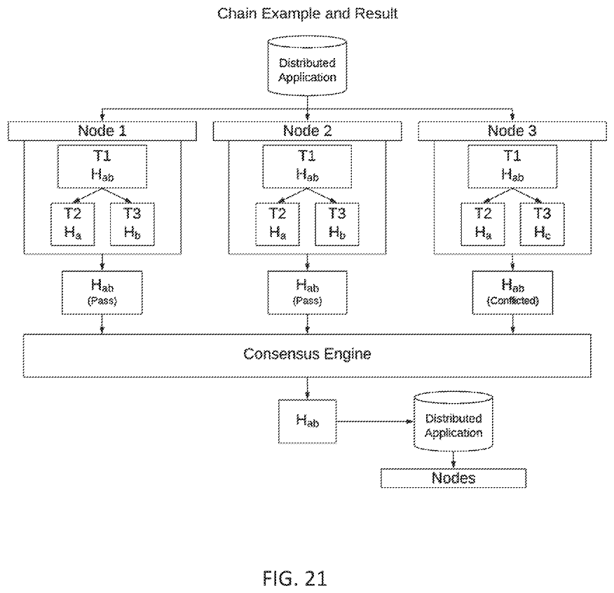

FIG. 21 depicts an exemplary chain example and results.

Various modifications and adaptations may become apparent to those skilled in the relevant arts in view of the foregoing description, when read in conjunction with the accompanying drawings. However, all such and similar modifications of the teachings of the disclosed embodiments will still fall within the scope of the disclosed embodiments.

Various features of the different embodiments described herein are interchangeable, one with the other. The various described features, as well as any known equivalents can be mixed and matched to construct additional embodiments and techniques in accordance with the principles of this disclosure.

Furthermore, some of the features of the exemplary embodiments could be used to advantage without the corresponding use of other features. As such, the foregoing description should be considered as merely illustrative of the principles of the disclosed embodiments and not in limitation thereof.

1. A transaction and identity verification system comprising:
a processor;
a memory including computer program code;
wherein executing the computer program code by the processor causes the transaction and identity verification system to utilize a private permissioned distributed ledger to:
qualify users for different capabilities within the system using a registration process; and
verify identities and purchase eligibilities of the users.

2. The transaction and identity verification system of claim 1, wherein the registration process comprises searching publicly available datasets to locate a most probable match of the users' identity.

3. The transaction and identity verification system of claim 1, wherein the registration process comprises formulating a series of knowledge-based authentication questions which the users must answer.

4. The transaction and identity verification system of claim 1, wherein the registration process comprises using a confidence scoring engine to calculate a user confidence score from data being collected about the users.

5. The transaction and identity verification system of claim 1, wherein utilizing the private permissioned distributed ledger to verify identities and purchase eligibilities of the users comprises referencing the users identity against public and proprietary watch lists in order to confirm purchase eligibility.

6. The transaction and identity verification system of claim 1, wherein executing the computer program code by the processor causes the transaction and identity verification system to utilize the private permissioned distributed ledger to execute smart contracts to control and record user transactions.

7. The transaction and identity verification system of claim 1, wherein executing the computer program code by the processor causes the transaction and identity verification system to utilize the private permissioned distributed ledger to register a dispensary for operation within the transaction and identity verification system.

8. The transaction and identity verification system of claim 7, wherein registering the dispensary for operation comprises using a confidence scoring engine to calculate a dispensary confidence score from data collected about the dispensary.

9. The transaction and identity verification system of claim 1, wherein executing the computer program code by the processor causes the transaction and identity verification system to utilize the private permissioned distributed ledger to create transaction compliance records for financial institution users.

10. A method for verifying transactions and identities in a cannabis dispensary system comprising:
utilizing a private permissioned distributed ledger to:
qualify users for different capabilities within the system using a registration process; and
verify identities and purchase eligibilities of the users.

11. The method of claim 10, wherein the registration process comprises searching publicly available datasets to locate a most probable match of the users' identity.

12. The method of claim 10, wherein the registration process comprises formulating a series of knowledge-based authentication questions which the users must answer.

13. The method of claim 10, wherein the registration process comprises calculating a user confidence score from data being collected about the users.

14. The method of claim 10, wherein, verifying identities and purchase eligibilities of the users comprises referencing the customers' identity against public and proprietary watch lists in order to confirm purchase eligibility.

15. The method of claim 10, comprising utilizing the private permissioned distributed ledger to execute smart contracts to control and record user transactions.

16. The method of claim 10, comprising utilizing the private permissioned distributed ledger to register a dispensary in order to verify transactions performed by the dispensary.

17. The method of claim 16 comprising utilizing using a confidence scoring engine to calculate a dispensary confidence score from data collected about the dispensary.

18. The method of claim 10 comprising utilizing the private permissioned distributed ledger to create transaction compliance records for financial institution users.

19. A transaction and identity verification system comprising:
one or more nodes through which users may access facilities provided by the transaction and identity verification system, each node comprising:
a processor;
a memory including computer program code;
wherein executing the computer program code by the processor causes each node of the transaction and identity verification system to register a user by:
verifying an identity of the user;
creating a unique user identifier and a user record for the user;
creating a smart contract to manage transactions involving the user, and
publishing the unique user identifier, user record, and smart contract to a private distributed ledger.

20. The transaction and identity verification system of claim 19, wherein the user is associated with the purchase of legal cannabis.

21. The transaction and identity verification system of claim 19, further comprising a confidence scoring engine for providing a confidence score of the registration.

22. The transaction and identity verification system of claim 21, wherein the confidence scoring engine operates to aggregate attributes of the transaction to determine an accuracy of data associated with the transaction.

23. The transaction and identity verification system of claim 21, wherein the smart contract comprises logic to control the transactions according to regulatory requirements and the confidence score.

24. The transaction and identity verification system of claim 19, further comprising a consensus engine configured to:
provide details of an individual transaction to a subset of nodes that each determine a state of the distributed ledger and predict a distributed ledger state resulting from processing the individual transaction;
upon a specified number of the subset of nodes predicting the same ledger state, order the individual transaction with other transactions; and
broadcast the ordered transactions to all of the nodes for publication to the distributed ledger.

25. The transaction and identity verification system of claim 19, wherein the private distributed ledger comprises a private permissioned block chain.

26. A method of verifying transactions and verifying user identities in a cannabis dispensary comprising:
using a node through which users may access facilities provided by the transaction and identity verification system to register a user by:
verifying an identity of the user;
creating a unique user identifier and a user record for the user;
creating a smart contract to manage transactions involving the user, and
publishing the unique user identifier, user record, and smart contract to a private distributed ledger.

27. The method of claim 26, further comprising using a confidence scoring engine to provide a confidence score of the registration by aggregating attributes of the transaction to determine an accuracy of data associated with the transaction.

28. The method of claim 26, further comprising using the smart contract to control the transactions according to regulatory requirements and the confidence score.

29. The method of claim 26, further comprising using a consensus engine to:
provide details of an individual transaction to a subset of nodes that each determine a state of the distributed ledger and predict a distributed ledger state resulting from processing the individual transaction;
upon a specified number of the subset of nodes predicting the same ledger state, order the individual transaction with other transactions; and
broadcast the ordered transactions to all of the nodes for publication to the distributed ledger.

30. The method of claim 26, wherein the private distributed ledger comprises a private permissioned block chain.
